(19) United States
(12) Patent Application Publication
(10) Pub. No.: US 2014/0205817 A1
(43) Pub. Date: Jul. 24, 2014

(54) IMAGE TRANSFER KIT AND METHOD OF MAKING SAME

(71) Applicant: BION DESIGN, LLC, New York, NY (US)

(72) Inventors: THOMAS CHARLES CONTI, EAST MEADOW, NY (US); ANDREW DES VIGNES, NEWARK, NJ (US); JAMES TOWNSEND, BRONX, NY (US)

(73) Assignee: BION DESIGN, LLC, NEW YORK, NY (US)

(21) Appl. No.: 13/749,611

(22) Filed: Jan. 24, 2013

(51) Int. Cl. B41M 5/52; B05D 7/26

(52) U.S. Cl. CPC B41M 5/52; B05D 7/26
USPC 428/201; 427/558

(57) ABSTRACT

A process of manufacturing an image transfer kit which enables the production of a desired image on a substrate which subsequently may be used in different decorative applications. The process may include the application of different layers of lacquer, photoclear and inks to a substrate in addition to the ultra-violet light treatment, washing and drying of the substrate at certain stages during the process. The produced image transfer kit may include the substrate, layers of transfer lacquer, high resolution lacquer, photoclear, clear or white ink, adhesive and the desired image.

### FIELD OF THE INVENTION

The present invention is generally related to processes for making or manufacturing image transfer kits which enable the production of a desired image or design on a substrate which then may be used in a number of decorative applications.

### BACKGROUND OF THE INVENTION

People wish to use decorative images in a number of applications. For instance, some people use decorative images to decorate their finger nails and their toe nails. In doing so, they normally encounter the problem of decorating their nails (either fingernails or toenails) with graphics and/or images that cannot withstand a protective coat of lacquer. The graphics and/or images are also apt to be dissolved by the same coat of lacquer when applied. As such, there is a need for an image transfer kit that will enable the desired image to withstand the coat of lacquer and remain durable for a number of days.

### SUMMARY OF THE INVENTION

In light of the foregoing problems it is an object of the present invention to provide an image transfer kit that would enable an image to withstand a coat of lacquer applied on a user's nail. It is also an object of the present invention to provide a method for manufacturing an image transfer kit.

In an aspect of an embodiment of the present invention, the manufacturing method or process may include the steps of creating actual and silhouette film negatives of a desired image, applying a layer of transfer lacquer onto a substrate, applying a layer of high resolution lacquer over the layer of transfer lacquer, applying a layer of photoclear over the layer of high resolution lacquer, exposing the substrate to ultraviolet light following application of the photoclear layer, applying colored ink over the layer of photoclear and exposing the substrate to ultraviolet light following the application of colored ink.

In another aspect of an embodiment of the present invention, the process may include the steps of washing the substrate after the application of the transfer lacquer layer and drying the substrate after the washing.

In another aspect of an embodiment of the present invention, the process may include the steps of washing the substrate after the application of the high resolution lacquer layer and drying the substrate after the washing.

In another aspect of an embodiment of the present invention, the process may include the steps of washing the substrate after the application of the photoclear layer and drying the substrate after the washing.

In another aspect of an embodiment of the present invention, the process may include the steps of washing the substrate after application of the layer of colored ink and drying the substrate after the washing.

In an aspect of an embodiment of the present invention, the silhouette film negative may be placed between the ultraviolet light and the substrate when exposing the substrate to ultraviolet light following application of the photoclear layer.

In an aspect of an embodiment of the present invention, the actual film negative may be placed between the ultraviolet light and the substrate when the substrate is exposed to ultraviolet light following the application of colored ink.

In an aspect of an embodiment of the present invention, the process may further include the steps of applying a layer of white or clear ink over the layer of colored ink and applying a layer of adhesive to the layer of white or clear ink.

In an aspect of an embodiment of the present invention, the process may further include the steps of washing the substrate after the substrate's exposure to ultraviolet light following application of the photoclear layer, and drying the substrate after the washing process.

In an aspect of an embodiment of the present invention, the step of applying colored ink may be repeated each time for the number and quantity of inks required to generate the image. In another aspect of an embodiment of the present invention, this step of applying colored ink may include the step of determining which ink color components are required for the image.

In an aspect of an embodiment of the present invention, the process may include the step of exposing, after application of the clear or white ink, the substrate to ultraviolet light. In an aspect, during this process, the substrate may be exposed with the silhouette film negative placed between the ultraviolet light and the substrate. In another aspect of an embodiment of the present invention, the process may include the steps of washing the substrate after the substrate's exposure to ultraviolet light and drying the substrate after the washing.

In yet another aspect of an embodiment of the present invention, the image transfer kit may include a substrate, a layer of transfer lacquer atop the substrate, a layer of high resolution lacquer atop the layer of transfer lacquer, a layer of photoclear atop the layer of high resolution lacquer, an image, atop the layer of photoclear, a layer of clear or white ink laid upon the image, and a layer of adhesive on top of the layer of clear or white ink.

In yet another aspect of an embodiment of the present invention, the image may be formed by the integration of colored inks onto the substrate after exposure of both the silhouette and actual film negatives of the image to ultraviolet light in conjunction with the substrate at different stages of the process. In an aspect, each ink represents the colors needed to generate the colors of the image.

In yet another aspect of an embodiment of the present invention, the image transfer kit may include a backing layer atop the layer of adhesive. In one aspect, the backing layer may be made of silicone based paper.

### BRIEF DESCRIPTION OF THE DRAWINGS

The features and advantages of aspects of embodiments of the present invention will become more apparent from the detailed description set forth below when taken in conjunction with the claims and drawings, in which like reference numbers indicate identical or functionally similar elements. Additionally, the left-most digit of a reference number identifies the drawing in which the reference number first appears.

FIG. 1 illustrates a flow chart showing the manufacturing process according to an exemplary aspect of the present invention.

FIG. 2 illustrates an image transfer kit according to an exemplary aspect of the present invention showing the different layers or components of the kit.

### DETAILED DESCRIPTION OF THE INVENTION

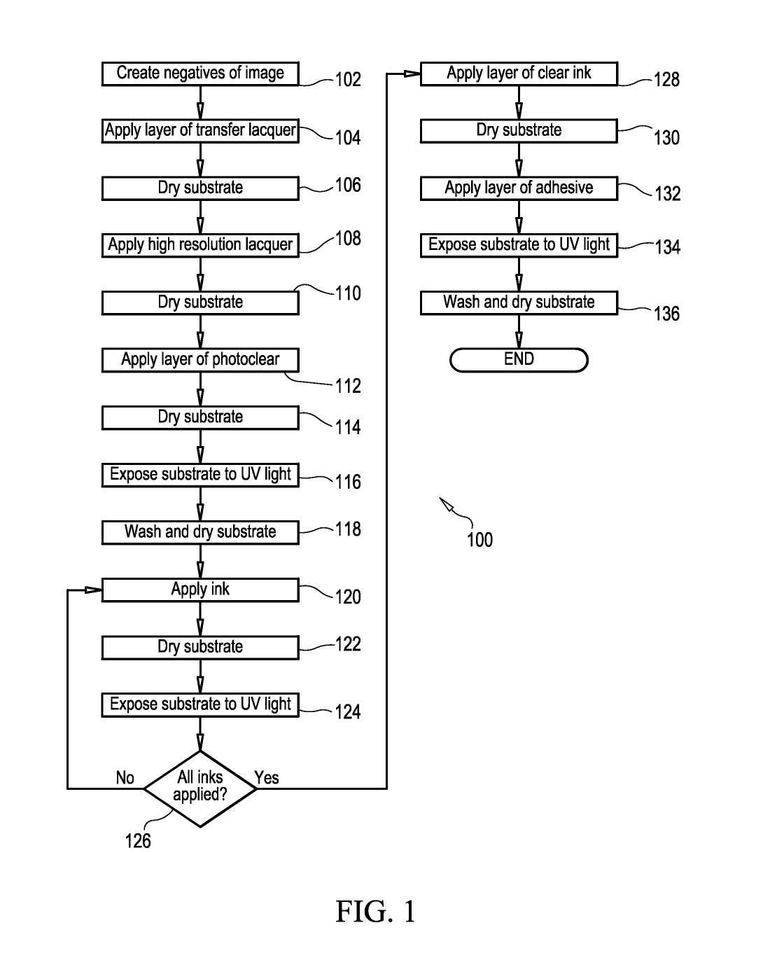

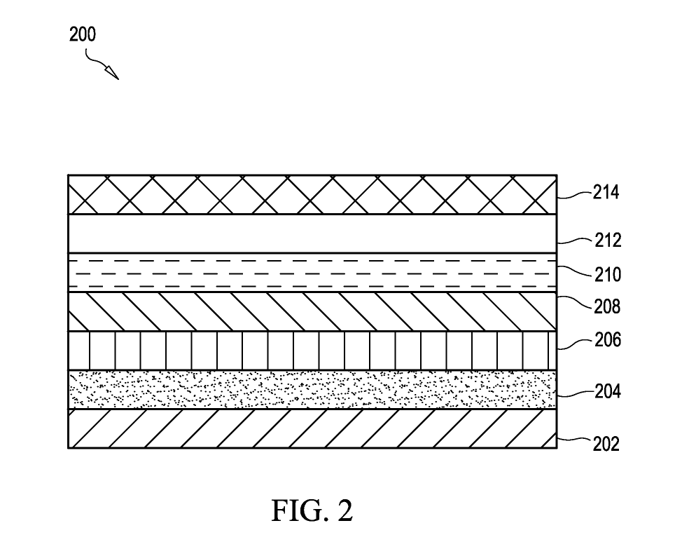

Referring now to FIGS. 1 and 2, a flow chart showing the manufacturing process 100 and an image transfer kit 200 according to exemplary aspects of embodiments of the present invention are shown. As seen in FIG. 1, the manufacturing process 100 may begin at step 102 with the creation of both actual and silhouette negatives of the image or design sought to be used. A silhouette negative may be used in order to capture or trap all the information contained in the image. In one aspect of an embodiment of the present invention, the silhouette negative may be slightly larger than the actual negative.

Following the creation of the negatives, a layer of transfer lacquer 204, in step 104 is applied to a substrate 202. In one aspect, substrate 202 may be made of vinyl, plastic or the like. In applying transfer lacquer layer 204, a lacquer transfer rod may be used to create an even coating of the lacquer layer. Substrate 202 is then, in step 106 dried.

After the substrate has been dried in step 106, a layer of high resolution lacquer 206, is then applied over the initial transfer lacquer later 204. The substrate, after application of the high resolution lacquer layer 206, is then dried in step 110. In another aspect of an embodiment of the present invention, a substance or layer of material, which is capable of enabling water based inks to adhere to it, may be used in lieu of the high resolution lacquer layer.

A layer of photoclear 208, in step 112, is applied on top of high resolution lacquer layer 206. With the photoclear layer 208 as a barrier coat, the desired image may be protected from the layers or lacquer and a durable decorative image is provided, for instance, on finger or toe nail, if that is the desired decorative application. Following the application of photoclear layer 208, a water based transfer rod may be used, in one aspect of an embodiment of the present invention, to even out the photoclear layer across substrate 202. Substrate 202, with photoclear layer 208 having been applied to it, is then dried in step 114.

Substrate 202, in step 116, is exposed to ultraviolet light. In one embodiment, the silhouette negative of the image may be placed between the ultraviolet light and substrate 202 during this exposure step. Substrate 202 is then exposed for a predetermined amount of time after which it is washed (to remove any excess photoclear and/or lacquer) and dried in step 118. In one aspect, the photoclear and lacquer layers would be hardened during this exposure step.

Next, a layer of ink 210 is applied on top of photoclear layer 208 in step 120 Ink layer 210, in one aspect, may be evenly applied using either a solvent or water based transfer rod. In another aspect of an embodiment of the present invention, digital printing technology may be employed to replace manual application of the ink(s) onto the substrate. This would reduce production costs and increase the speed of production. Use of digital printing technology would also increase production flexibility and allow for more customized orders and/or designs/images to be used.

Ink layer 210 of substrate 202 is then dried in step 122. After the ink layer has been dried in step 122, the substrate, in step 124, is exposed for a predetermined amount of time to ultraviolet light. In one aspect of an embodiment of the present invention, the actual negative of the image may be placed between the ultraviolet light and substrate 202. At step 126, after the exposure of the substrate to ultraviolet light, a determination is made as to whether to repeat the ink application process depending on the different inks—cyan, magenta, yellow and black—which are needed for the image. If an additional ink (or additional amount of a particular ink) is needed, the process reverts back to step 120 through step 126 until all inks (or requisite quantities) have been applied.

After application of the ink(s), the process proceeds to step 128 where a layer of either clear ink or white ink 212 is applied on top of ink layer 210. This layer of clear ink or white ink 212 is then dried (step 130) and a layer of adhesive 214, in step 132, is applied on top of the layer of clear or white ink 210.

Next, in step 134, substrate 202 (now with the multiple layers) is once again exposed, for a predetermined amount of time, to ultraviolet light. In one aspect of an embodiment of the present invention, the silhouette negative may be placed between the ultraviolet light and substrate 202 during this step. Substrate 202 is then spray washed (to remove any excess clear or white ink) and dried in step 136. At this point, an image transfer kit 200 is produced having a printed image on substrate 202 with adhesive layer 214 on the back of the image.

Referring now to FIG. 2, an image transfer kit 200 according to an exemplary aspect of an embodiment of the present invention is shown. Image transfer kit 200, as briefly described above and in one aspect of an embodiment of the present invention may have a substrate 202 upon which a layer of transfer lacquer 204 is applied and dried.

After the substrate has been dried, a layer of high resolution lacquer 206, is then applied over the initial transfer lacquer later 204. The substrate, after application of the high resolution lacquer layer 206, is then dried. In an aspect of an embodiment of the present invention, a substance or layer of material, which is capable of enabling water based inks to adhere to it, may be used in lieu of the high resolution lacquer layer.

Once the layer of high resolution lacquer is dried, a layer of photoclear 208 is laid over the layer of high resolution lacquer 206. Next, after drying, washing & drying and ultraviolet light treatment of substrate 202 with the transfer lacquer layer 204, high resolution lacquer layer 206 and photoclear layer 208, an ink layer 210 is laid over photoclear layer 208 Ink layer 210 provides the necessary colors or color combinations for the desired image. Next a layer of clear or white ink 212 is laid on top of ink layer 210 (i.e. the image generated by the application of inks) Finally, adhesive layer 214 is laid over the layer of clear or white ink 212. In one aspect of an embodiment of the present invention, a backing sheet or layer (not shown) may be applied on top of the adhesive layer. In one aspect, the backing sheet may be made of silicone based paper.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as defined in the appended claims.

What is claimed is:

1. A method of manufacturing an image transfer kit, comprising the steps of:
Creating actual and silhouette film negatives of an image;
Applying a layer of transfer lacquer onto a substrate;
Applying a layer of high resolution lacquer over the layer of transfer lacquer;
Applying a layer of photoclear onto the layer of high resolution lacquer;
Exposing the substrate to ultraviolet light following application of the photoclear layer;
Applying colored ink over the layer of photoclear; and
Exposing the substrate to ultraviolet light following the application of colored ink.

2. The method of claim 1, wherein the silhouette film negative is placed between the ultraviolet light and the substrate when exposing the substrate to ultraviolet light following application of the photoclear layer.

3. The method of claim 1, wherein the actual film negative is placed between the ultraviolet light and the substrate when the substrate is exposed to ultraviolet light following the application of colored ink.

4. The method according to claim 1, further comprising the steps of:
Applying a layer of white or clear ink on top of the layer of colored ink; and
Applying a layer of adhesive to the layer of white or clear ink.

5. The method according to claim 1, further comprising the steps of:
Washing the substrate after the substrate's exposure to ultraviolet light following application of the photoclear layer; and
Drying the substrate after its washing.

6. The method according to claim 1, wherein the step of applying colored ink is repeated each time for the number and quantity of inks required to generate the image.

7. The method according to claim 6, wherein the step of applying colored ink comprises of the step of determining which ink color components are required for the image.

8. The method according to claim 4, further comprising the step of exposing, following the application of the clear or white ink, the substrate to ultraviolet light wherein the silhouette film negative is placed between the ultraviolet light and the substrate.

9. The method according to claim 8, further comprising the steps of:
Washing the substrate after the substrate's exposure to ultraviolet light; and
Drying the substrate after its washing.

10. The method according to claim 1, further comprising the steps of:
Washing the substrate after the application of the transfer lacquer layer; and
Drying the substrate after its washing.

11. The method according to claim 1, further comprising the steps of:
Washing the substrate after the application of the high resolution lacquer layer; and
Drying the substrate after its washing.

12. The method according to claim 1, further comprising the steps of:
Washing the substrate after the application of the photoclear layer; and
Drying the substrate after its washing.

13. The method according to claim 1, further comprising the steps of:
Washing the substrate after application of the layer of colored ink; and
Drying the substrate after its washing.

14. An image transfer kit, comprising:
A substrate;
A layer of transfer lacquer atop the substrate;
A layer of high resolution lacquer atop the layer of transfer lacquer;
A layer of photoclear atop the layer of high resolution lacquer;
An image, atop the layer of photoclear;
A layer of clear or white ink laid upon the image; and
A layer of adhesive on top of the layer of clear or white ink.

15. The image transfer kit according to claim 15, wherein said image is formed by the integration of colored inks onto the substrate and exposure of silhouette and actual film negatives of the image to ultraviolet light in conjunction with the substrate, and where each ink represents the colors needed to generate the colors of the image.

16. The image transfer kit according to claim 15, further comprising a backing layer atop the layer of adhesive.
